(19) United States
(12) Patent Application Publication
(10) Pub. No.: US 2013/0337284 A1
(43) Pub. Date: Dec. 19, 2013

(54) RESISTANCE WELDING METHOD, RESISTANCE-WELDED MEMBER, RESISTANCE WELDER AND CONTROL APPARATUS THEREOF, CONTROL METHOD AND CONTROL PROGRAM FOR RESISTANCE WELDER, AND RESISTANCE WELDING EVALUATION METHOD AND EVALUATION PROGRAM

(71) Applicants: Takahiro Onda, Nagoya-shi (JP); Goro Watanabe, Tajimi-shi (JP); Morimasa Murase, Takahama-shi (JP); Yasuhiro Ishii, Nisshin-shi (JP); Tsunaji Kitayama, Nagoya-shi (JP); Hisaaki Takao, Seto-shi (JP); Hideki Teshima, Miyoshi-shi (JP); Yoshinori Shibata, Nagoya-shi (JP); Tokujiro Konishi, Toyota-shi (JP); Naotoshi Tominaga, Toyota-shi (JP)

(72) Inventors: Takahiro Onda, Nagoya-shi (JP); Goro Watanabe, Tajimi-shi (JP); Morimasa Murase, Takahama-shi (JP); Yasuhiro Ishii, Nisshin-shi (JP); Tsunaji Kitayama, Nagoya-shi (JP); Hisaaki Takao, Seto-shi (JP); Hideki Teshima, Miyoshi-shi (JP); Yoshinori Shibata, Nagoya-shi (JP); Tokujiro Konishi, Toyota-shi (JP); Naotoshi Tominaga, Toyota-shi (JP)

(73) Assignee: TOYOTA JIDOSHA KABUSHIKI KAISHA, Toyota-shi, Aichi-ken (JP)

(21) Appl. No.: 13/980,424

(22) PCT Filed: Mar. 2, 2012
(86) PCT No.: PCT/IB12/00393

§ 371 Date: Jul. 18, 2013

(30) Foreign Application Priority Data
Mar. 4, 2011 (JP) 2011-047244

(51) Int. Cl. B23K 11/25; B32B 7/04; B32B 15/01

(52) U.S. Cl. CPC B23K 11/25; B32B 15/011; B32B 7/045
USPC 428/594; 219/117.1; 219/109

(57) ABSTRACT

A resistance welding method according to the invention includes: a melting start time specification process for specifying a melting start time, which is a time at which at least a part of a welding portion of a welding subject starts to melt while being subjected to Joule heating by a power input from an electrode pressed against the welding subject, by detecting a variation in an ultrasonic wave emitted toward the welding portion; a first power amount calculation process for calculating a first power amount, which is an integrated value of the power input into the welding subject via the electrode from the melting start time; a first determination process for determining whether or not the first power amount has reached a first set value; and a heating process for performing the Joule heating from the melting start time until the first power amount reaches the first set value.

### BACKGROUND OF THE INVENTION

1. Field of the Invention

The invention relates to resistance welding such as spot welding.

2. Description of Related Art

When a plurality of materials are to be joined, welding is employed for its low cost and the ease with which strength can be secured. Spot welding, in which welding is performed at a plurality of points (spots), is employed particularly often to weld laminated steel plates (a plurality of welding subjects) forming a body of an automobile or the like. Spot welding is a typical type of resistance welding in which the welding subjects are joined by passing a large current through the welding subjects for a short time from electrodes sandwiching respective outer sides of the welding subjects such that a joint part (a welding portion) on respective inner sides of the welding subjects melts and then solidifies.

Incidentally, spot welding differs from arc welding and the like in that the welding portion is positioned inside the welding subjects, making it difficult to observe a welding condition directly with the eyes or the like. Furthermore, in a mass production process, it is difficult for an operator to inspect a very large number of welding spots one by one. In consideration of these circumstances, a welding method with which the quality of the spot welding is stabilized, a method of inspecting nuggets (melted and solidified portions of the welding subjects) formed during the spot welding, and the like have been proposed.

For example, Japanese Patent Application Publication No. 62-64483 (JP 62-64483 A) describes performing resistance welding by applying a welding current until an actually supplied actual energy value matches a target total energy value. On an actual welding site, however, spot welding is performed under various unexpected conditions (disturbances). For example, in a case where two steel plates serving as the welding subjects are resistance-welded, a gap may exist between the steel plates to be joined by the welding, the steel plates may tilt, and a tip end portion of an electrode pressed against the steel plates may become worn. When such disturbances exist, a contact condition (in particular, a contact surface area) between the steel plates varies. As a result, variation occurs in an amount of heat required for effective welding. It is therefore difficult to stabilize the welding quality simply by focusing on a total energy (total amount of power) input into the welding subjects from the start of energization, i.e. without taking disturbances into account.

Further, Japanese Patent Publication No. 55-2582, WO1994/003799 (Japanese Patent No. 3644958), and Japanese Patent Application Publication No. 2007-248457 (JP 2007-248457 A) describe a method of inspecting or evaluating a size of a spot-welded welding portion (a nugget) using ultrasonic waves. In all of these documents, the size of the spot-welded welding portion (a nugget diameter) is estimated or evaluated on the basis of an amount of variation (for example, a peak value difference or a time difference up to intensity variation) between two certain points of an ultrasonic wave that varies throughout the welding process. Even if such methods are effective, they serve simply to estimate the nugget diameter, and therefore stabilization of the quality of spot welding remains difficult. Moreover, the above documents provide no description or the like thereof.

### SUMMARY OF THE INVENTION

The invention provides a resistance welding method with which a quality of resistance welding can be stabilized even when a disturbance occurs in a condition of a welding portion (a joint between welding subjects), a contact condition between the welding subject and an electrode, and so on while actually welding the welding subjects, and a resistance-welded member obtained thereby.

The invention also provides a resistance welder suitable for implementing the aforesaid welding, as well as a control method, a control apparatus, and a control program thereof. The invention further provides an evaluation method and an evaluation program for evaluating the welding.

As a result of committed research and repeated trial and error with the aim of solving the aforesaid problems, the inventor has newly discovered that even when various disturbances exist on a welding site, these disturbances have substantially no effect once a Joule-heated welding subject begins to melt, and therefore, by advancing resistance welding in accordance with an input energy (an input power amount) and adjusting the input energy (input power amount), a desired nugget can be formed. Further, the inventor confirmed his discovery in reality by arriving at the idea of detecting a melting start point of the welding subject, i.e. a starting point of the input power amount, using ultrasonic waves. By developing this accomplishment, the inventor arrived at various inventions relating to resistance welding, to be described below.

[Resistance Welding Method]

A resistance welding method according to a first aspect of the invention includes: a melting start time specification process for specifying a melting start time, which is a time at which at least a part of a welding portion of a welding subject starts to melt while being subjected to Joule heating by a power input from an electrode pressed against the welding subject, by detecting a variation in an ultrasonic wave emitted toward the welding portion; a first power amount calculation process for calculating a first power amount, which is an integrated value of the power input into the welding subject via the electrode from the melting start time; a first determination process for determining whether or not the first power amount or a welding index value that indexes a welding condition of the welding portion and corresponds to the first power amount has reached at least a first set value; and a heating process for performing the Joule heating from the melting start time until the first power amount or the welding index value reaches at least the first set value. Thus, a nugget generated when the welding portion melts and solidifies can be formed with stability.

In the resistance welding method described above, first, after resistance welding of the welding subject has begun, or in other words after the electrode has been energized in order to Joule-heat the welding subject, the time (melting start time) at which at least a part of the welding portion of the welding subject starts to melt as a result of the Joule heating is detected accurately in accordance with variation in the ultrasonic wave emitted toward the welding portion.

Next, an energy (input power amount) input into the welding subject is calculated using the melting start time as a starting point. Although the reasons and mechanisms thereof are as yet identified, by focusing on the first power amount, i.e. the amount of power input from the melting start time onward, the size of the nugget formed in the welding portion of the welding subject can be controlled appropriately even in a situation where various disturbances exist. More specifically, Joule heating is performed until the first power amount obtained by integrating the input power amount from the melting start time onward or the welding index value obtained by converting the first power amount into a nugget size (a nugget diameter) or the like reaches at least a predetermined set value (the first set value). Hence, welding defects caused by excessive or insufficient input power, dust generated by excessive input power, and so on can be prevented even on a welding site where various disturbances exist, and as a result, the welding quality can be stabilized efficiently.

Note that energy (intensity) variation, transmittance variation, reflectance variation, spectral intensity variation, and so on may be cited as examples of the “variation in the ultrasonic wave” according to this specification. However, amplitude variation is used as a representative example. There are no limitations on the type of ultrasonic wave, and either a longitudinal wave or a transverse wave may be used.

The term “reaches at least the set value” includes a case in which a subject value is contained within a specific range. The set value may be an upper limit value (a final target value) or a minimum reached value (a lower limit value). In the case of this aspect, the heating process may be stopped when the calculated first power value or the corresponding welding index value reaches the first set value, or continued for as long as the first power value or welding index value remains within a certain range exceeding the first set value. There are no limitations on a method of calculating the “power amount”.

Specific numerical values of the respective power amounts described in this specification are not important in themselves as long as they serve as accurate indices correlating with the diameter and so on of the nugget formed on the welding subject. Further, the “welding index value” may be any value that indexes the condition of the resistance welding accurately, a representative example thereof being the nugget diameter.

Further, the term “time” (for example, the melting start “time” and a rapid reduction “time”) according to this specification includes not only a single positive point in time but also the vicinity of that point, and may as a matter of course include a time width required to realize the resistance welding.

Incidentally, in the resistance welding method according to the invention, the melting start time must be specified accurately to achieve stability in the welding quality of the welding subject on the basis of the first power amount calculated from the melting start time. When a “disturbance” occurs such that a disposal condition of the welding subject, a contact condition between the welding subject and the electrode, and so on deviate from originally envisaged conditions (standard conditions), the time remaining to the melting start time varies. This fact is corroborated by actual test results. Hence, at first glance, it appears to be difficult to specify the melting start time with a high degree of precision.

The melting start time is basically the point at which the welding portion of the welding subject begins to vary from a solid phase to a liquid phase, and at this time, physical property values (a temperature, a volumetric change, and so on) of the melted portion vary. It is therefore possible to specify the melting start time by focusing on variation in the physical property values of the welding portion. However, it is not easy to detect this variation directly and accurately in the extremely brief period during which resistance welding is performed. Hence, according to the invention, the melting start time is successfully specified with accuracy by detecting condition variation (phase variation) in the welding portion indirectly using an ultrasonic wave. More specifically, this is achieved as follows.

The ultrasonic wave emitted toward the welding subject separates into a transmitted wave that passes through the welding subject and a reflected wave reflected near a surface of the welding subject. When condition variation (phase variation) occurs in the welding subject, rapid variation occurs in at least the amplitude (or intensity) of both the transmitted wave and the reflected wave. The reason for this is that when the part on which the ultrasonic wave impinges varies from the solid phase to the liquid phase or from the liquid phase to the solid phase, a density and an acoustic velocity of that part varies, leading to rapid variation in an acoustic impedance.

Therefore, a timing at which the amplitude of the ultrasonic wave (the transmitted wave or the reflected wave) varies rapidly corresponds positively to the melting start time (the time at which phase variation from the solid phase to the liquid phase begins), and by detecting this timing, the melting start time can be specified precisely without being affected by disturbances, welding conditions (a current density, for example), and so on.

Incidentally, the inventor discovered through committed research that variation in the transmitted wave can be used to specify the melting start time accurately even when the welding portion is small. The reason for this is believed to be as follows. A reflected wave is likely to form on an interface between the electrode and the welding subject (steel plates or the like) at a midway point between an ultrasonic wave emission source and a welding location (the welding portion), but condition variation in the welding location (welding portion) has little effect on variation in the reflected wave. In other words, condition variation in the welding portion is not reflected greatly by variation in the reflected wave. A transmitted wave, on the other hand, invariably passes through the welding portion (welding location), and therefore condition variation therein is greatly reflected in the transmitted wave. Hence, using variation in the transmitted wave, it is comparatively easy to grasp the melting start time of the welding portion accurately.

Accordingly, the melting start time specification process according to the aspect described above may include: a transmitted wave amplitude detection process for detecting a transmitted wave amplitude, which is an amplitude of an ultrasonic wave that passes through the welding portion; and a rapid reduction time determination process for determining a rapid reduction time at which the transmitted wave amplitude falls to or below a second set value.

In the invention, a current value and a voltage value employed to energize the electrode that contacts the welding subject during the resistance welding do not necessarily have to be fixed. The current value and voltage value applied to the welding subject may be modified appropriately either before the first power amount reaches the first set value set in accordance with the desired nugget diameter or the like, or in relation to each welding spot. Accordingly, the heating process according to this aspect may include a heating modification process for modifying a heating condition of the welding subject on the basis of a determination result obtained in the first determination process. This may be applied similarly to a period extending from an energization start time of the electrode to the melting start time of the welding subject.

Note that the content described herein may be applied appropriately to a resistance welder, a control apparatus thereof, a control method thereof, a control program thereof, a resistance welding evaluation method, a resistance welding evaluation program, and so on, to be described below. In this case, the “processes” included in the configurations of the invention described above are to be read as “steps” or “units”, as appropriate.

[Resistance-Welded Member]

By employing the resistance welding method described above, a product in which welding defects are suppressed and the welding quality is stabilized can be obtained. Therefore, the invention may be understood not only as a resistance welding method, but also as a resistance-welded member having stable nugget shapes, which serves as a second aspect of the invention.

[Resistance Welder and Control Apparatus Thereof]

The invention may also be understood as a resistance welder and a control apparatus thereof for realizing the resistance welding method described above. More specifically, a third aspect of the invention relates to a control apparatus for a resistance welder having an electrode that contacts a welding subject externally and a power supply apparatus that supplies a heating current to the electrode in order to Joule-heat a welding portion of the welding subject. The control apparatus includes: a melting start time specification unit that specifies a melting start time, which is a time at which at least a part of the welding portion starts to melt while being subjected to Joule heating by a power input into the welding subject from the electrode, by detecting a variation in an ultrasonic wave emitted toward the welding portion; a first power amount calculation unit that calculates a first power amount, which is an integrated value of the power input into the welding subject via the electrode from the melting start time; a first determination unit that determines whether or not the first power amount or a welding index value that indexes a welding condition of the welding portion and corresponds to the first power amount has reached at least a first set value; and a heating unit that performs the Joule heating from the melting start time until the first power amount or the welding index value reaches at least the first set value.

Further, a fourth aspect of the invention relates to a resistance welder including: an electrode that is pressed against a welding subject; a power supply apparatus that supplies a heating current to the electrode in order to Joule-heat a welding portion of the welding subject; and the control apparatus described above, which controls a power amount input into the welding subject from the power supply apparatus.

[Control Method and Control Program for Resistance Welder]

Furthermore, the invention may be understood as a control method or a control program for the resistance welder described above. More specifically, a fifth aspect of the invention relates to a control method for a resistance welder having an electrode that contacts a welding subject externally and a power supply apparatus that supplies a heating current to the electrode in order to Joule-heat a welding portion of the welding subject. The control method for a resistance welder includes: a melting start time specification process for specifying a melting start time, which is a time at which at least a part of the welding portion starts to melt while being subjected to Joule heating by a power input into the welding subject from the electrode, by detecting a variation in an ultrasonic wave emitted toward the welding portion; a first power amount calculation process for calculating a first power amount, which is an integrated value of the power input into the welding subject via the electrode from the melting start time; a first determination process for determining whether or not the first power amount or a welding index value that indexes a welding condition of the welding portion and corresponds to the first power amount has reached at least a first set value; and a heating process for performing the Joule heating from the melting start time until the first power amount or the welding index value reaches at least the first set value.

A sixth aspect of the invention relates to a computer-readable storage medium that stores computer-executable instructions for performing the control method for a resistance welder described above.

[Resistance Welding Evaluation Method]

In addition, the invention may be understood as a resistance welding evaluation method and a resistance welding evaluation program. More specifically, a seventh aspect of the invention relates to a resistance welding evaluation method including: a melting start time specification process for specifying a melting start time, which is a time at which at least a part of a welding portion of a welding subject starts to melt while being subjected to Joule heating by a power input from an electrode pressed against the welding subject, by detecting a variation in an ultrasonic wave emitted toward the welding portion; a first power amount calculation process for calculating a first power amount, which is an integrated value of the power input into the welding subject via the electrode from the melting start time; and an estimating step for estimating a welding condition of the welding portion on the basis of the first power amount.

As described above, the melting start time specification process may include: a transmitted wave amplitude detection process for detecting a transmitted wave amplitude, which is an amplitude of an ultrasonic wave that passes through the welding portion; and a rapid reduction time determination process for determining a rapid reduction time at which the transmitted wave amplitude falls to or below a second set value.

Further, an eighth aspect of the invention relates to a computer-readable storage medium that stores computer-executable instructions for performing the resistance welding evaluation method described above.

Note that the aforesaid estimation process may be an evaluation process for evaluating the welding condition according to whether or not the calculated first power amount or the welding index value indexing the welding condition of the welding portion, which is determined from the first power amount, is within a predetermined range. Further, the estimation process may be a nugget estimation process for estimating, on the basis of the first power amount, the size of the nugget formed when the melting portion melts and solidifies.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an illustrative view illustrating various disturbances that may occur during resistance welding;

FIG. 2A is a graph showing a correlation between an input power amount input into a welding subject from an energization start point under various disturbances and a diameter of a formed nugget;

FIG. 2B is a graph showing a correlation between the input power amount input into the welding subject from a melting start time of the welding subject onward and the diameter of the formed nugget;

FIG. 3 is a schematic diagram showing a spot welder;

FIG. 4 is a schematic diagram showing the vicinity of a welding portion of the welding subject;

FIG. 5 is a schematic diagram showing a condition in which an oblique angle ultrasonic wave emission element and an oblique angle ultrasonic wave reception element are respectively attached in a diagonal direction to shaft portions of electrodes capable of sandwiching the welding subject from either side;

FIG. 6 is a schematic diagram showing a condition in which an ultrasonic wave emission element and an ultrasonic wave reception element are respectively attached in a perpendicular direction to the shaft portions of the electrodes capable of sandwiching the welding subject from either side;

FIG. 7A is a front view showing in detail the manner in which the oblique angle emission element is attached to the shaft portion of the electrode;

FIG. 7B is a plan view showing in detail the manner in which the oblique angle emission element is attached to the shaft portion of the electrode;

FIG. 8 is a graph showing the manner in which an amplitude of an ultrasonic wave (a transmitted wave) that passes through the welding portion varies in the vicinity of the melting start time; and

FIG. 9 is a flowchart of a spot welding method according to an embodiment of the invention.

### DETAILED DESCRIPTION OF EMBODIMENTS

The invention will now be described in detail, citing an embodiment thereof. The following description focuses mainly on a resistance welding method according to the invention, but the content of the description may be applied appropriately not only to the resistance welding method, but also to a resistance-welded member, a resistance welder, a control apparatus for the resistance welder, a control method for the resistance welder, a control program for the resistance welder, a resistance welding evaluation method, and a resistance welding evaluation program. The invention further encompasses configurations obtained by adding one or more configurations selected as desired from the configurations cited hereinafter to the configurations described above. The configurations to be added may be selected concomitantly or arbitrarily regardless of category. A decision as to which embodiment is optimum will differ according to subject, required performance, and so on.

[Resistance Welding and Disturbances]

In resistance welding, a joint is formed by energizing a welding portion via an electrode pressed against a welding subject such that resistance heat (Joule heat) is generated by various types of resistance existing in the welding portion, causing the welding portion to melt, and then cooling the welding portion until it solidifies.

A case in which a set of metallic plate materials are resistance-welded will be considered as a representative example. First, the set of plate materials serving as welding subjects are pressed into close contact by electrodes or the like. The electrodes are then energized such that a large amount of Joule heat is generated between contact surfaces (joints) of the adjacent plate materials, and as a result, the vicinity of the contact surfaces melts preferentially. When energization is complete, the welding subjects are cooled such that the melted part solidifies, and as a result, a nugget is formed. The resistance welding is then terminated.

The reason why the vicinity of the contact surfaces of the two or more joined welding subjects melts preferentially during resistance welding is that a contact resistance in this region is larger than the resistance in other parts. However, the contact resistance is greatly affected by a contact condition between the welding subjects, and furthermore, on an actual welding site, deviations (disturbances) from an initially envisaged contact condition (a standard condition) often occur. Therefore, even when conditions such as an applied current value, an energization period, and so on remain constant, a form of the formed welding portion may vary.

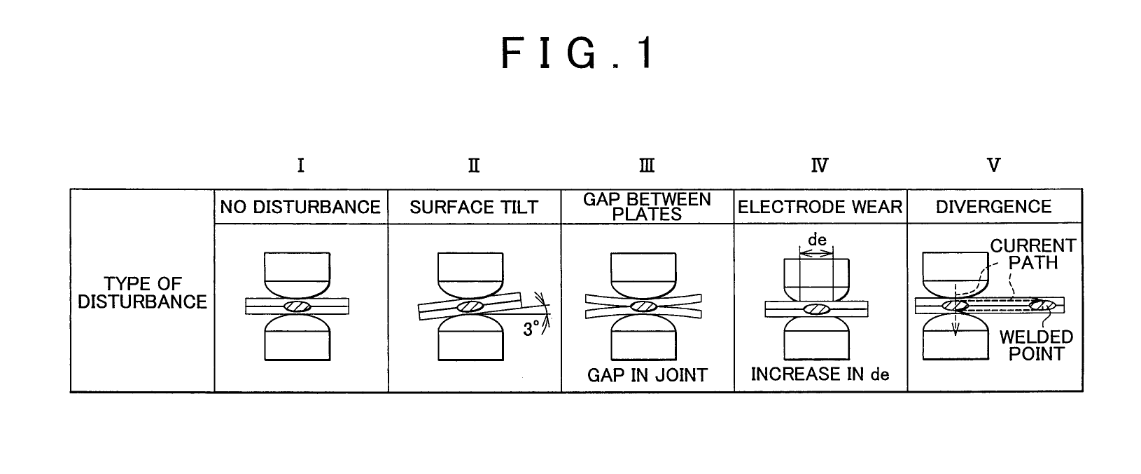

For example, when a disturbance illustrated in Pattern III of FIG. 1 exists, a contact area of the contact part is smaller than that of a case in which a disturbance illustrated in Pattern IV exists, and therefore the contact resistance increases. Even when a total current value passed through the electrode is identical in both cases, resistance in the contact part is larger in the former case, leading to an increase in a density of the current flowing through the contact part, and as a result, heat is generated rapidly by the contact part (in other words, a heat generation rate increases), causing the temperature of the contact part to rise rapidly.

Of course, if an amount of discharged heat and so on could be calculated accurately so that a sufficient amount of heat required for the welding could be input flexibly into the contact part, it would be possible to perform the welding with stability even when disturbances existed. In actuality, however, it is difficult to realize energization and heating in this manner. Hence, during conventional resistance welding, variation occurs in the form (nugget size) of the welding portion, and dust (a phenomenon occurring when metal particles scatter as the welding portion melts) is generated when an amount of input power is excessive. As a result, it is difficult to perform stable welding efficiently.

However, disturbances only affect the contact part between the welding subjects up to the start of melting, and have substantially no effect from the melting start time onward. With the invention, therefore, stability is achieved in the welding quality by inputting an amount of power (a first power amount) corresponding to a desired welding condition (the nugget size, for example) into the welding subject from the melting start time of the welding subject onward.

[First Power Amount Calculation Process]

The first power amount is calculated on the basis of a current passed through the electrode pressed against the welding subject and so on. The power amount is determined as a time-integrated value of the current and a voltage, but may be determined from a transformed formula thereof. The current passed through the electrode may be a direct current or an alternating current, and when an alternating current is applied, the power amount may be calculated on the basis of an effective value.

[First Determination Process]

In a first determination, the power amount calculated in the first power amount calculation process or an index value corresponding to the power amount is compared with a first set value. The first set value is selected appropriately depending on whether the subject of the comparison is the power amount or the index value. A representative index value is the size of the nugget (a nugget diameter) formed by melting and solidifying the welding portion of the welding subject.

[Melting Start Time Specification Process]

The melting start time is specified by detecting variation in an ultrasonic wave emitted toward the welding portion. The melting start time specification process preferably includes a transmitted wave amplitude detection process for detecting an amplitude of a transmitted wave, and a rapid reduction time determination process for determining a rapid reduction time of the transmitted wave amplitude.

The transmitted wave amplitude is detected by receiving an ultrasonic wave (transmitted wave) emitted from an ultrasonic wave sensor (emission element) so as to pass through the welding portion in a separate ultrasonic wave sensor (reception element), and detecting a waveform (amplitude) thereof. Structures, arrangements, attachment angles, attachment methods, and so on of the ultrasonic wave sensors may be selected or adjusted appropriately in consideration of the structure of a resistance welder, the type and arrangement of the welding subject, the detection precision of the melting start time, and so on.

For example, when the welding subjects are pressed respectively by a first electrode and a second electrode from two substantially coaxial sides, the emission element (ultrasonic wave sensor) that emits the ultrasonic wave is preferably attached to a shaft portion of the first electrode, and the reception element (ultrasonic wave sensor) that receives the ultrasonic wave emitted by the emission element is preferably attached to a shaft portion of the second electrode. The electrodes (more particularly, chips thereof) are replaced appropriately due to wear and the like, and therefore the emission element and reception element are preferably either attached to a non-replaceable part of the electrode or attached to a replaceable part but formed with a detachable structure so that they can be detached whenever the electrode is replaced.

Further, the angle at which the emission element and reception element are attached to the electrodes is selected appropriately. For example, oscillators (ultrasonic wave sensors) that emit or receive the ultrasonic wave are preferably attached to the shaft portions of the electrodes at an oblique angle oriented toward the welding portion. In other words, the emission element is preferably an oblique angle emission element that emits an ultrasonic wave in a direction of the welding subject from a diagonal direction relative to the shaft portion of the first electrode, and the reception element is preferably an oblique angle reception element that receives the ultrasonic wave emitted from the oblique angle emission element in the direction of the welding subject from a diagonal direction relative to the shaft portion of the second electrode.

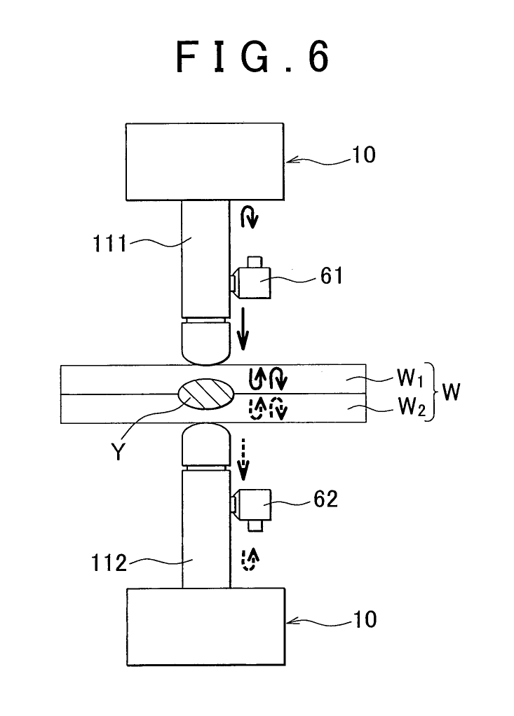

The reason for this is as follows. When the emission element is attached perpendicularly (90°) to the shaft portion of the electrode, an ultrasonic wave propagating through the shaft portion of the electrode disperses substantially evenly in both up and down directions of the shaft portion (a shank). As a result, a considerable amount of the emitted ultrasonic wave does not contribute to the detection of phase variation in the welding portion. These circumstances apply similarly to the reception element (see FIG. 6).

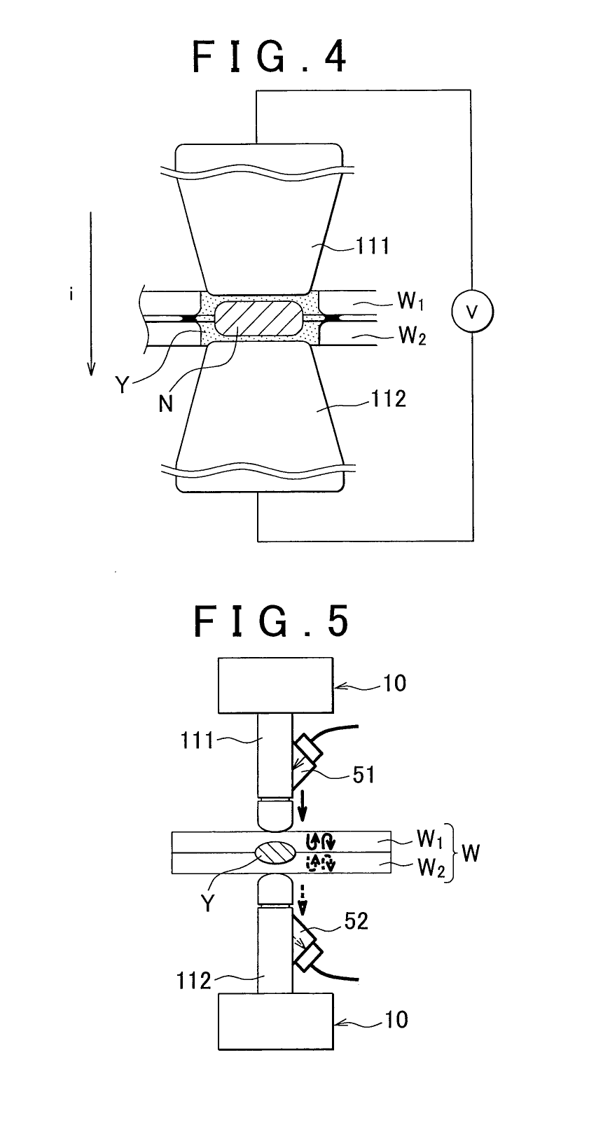

By employing the oblique angle emission element and the oblique angle reception element described above, ultrasonic wave propagation to an opposite side to the welding portion is suppressed, and therefore the majority of the ultrasonic wave can be used effectively to detect phase variation in the welding portion (see FIG. 5).

Further, multiple modes having different acoustic velocities may occur in the ultrasonic wave propagating through the electrode and the welding subject, but by adjusting the attachment angle of the oblique angle emission element and the oblique angle reception element appropriately, it is possible to excite and receive only ultrasonic waves in a specific mode (a single mode). As a result, phase variation in the welding portion (a rapid reduction in the amplitude of the transmitted wave) can be detected with a high degree of precision.

Note that the oscillators of the emission element and the reception element may be formed in a planar shape, but are preferably formed in a cylindrical surface shape or a conical surface shape that surrounds the shaft portion of the electrode (in particular a shape that is concentric with the shaft portion of the electrode). In so doing, the energy of the emitted and received ultrasonic wave can be increased and a non-axisymmetric mode of the ultrasonic wave can be suppressed. As a result, the waveform of the received transmitted wave can be analyzed easily, and variation in the ultrasonic wave in the vicinity of the melting start time can be detected with a high degree of precision.

Further, the ultrasonic wave propagating through the shaft portion of the electrode is reflected by a tip end of the electrode (a tip end of the electrode chip) or the like. Accordingly, multiple reflection waves may be generated in the ultrasonic wave inside the shaft portion of the electrode. When the multiple reflection waves are strong, it becomes difficult to detect variation in the ultrasonic wave accurately. Therefore, an ultrasonic wave damping material that damps or absorbs the multiple reflection waves may be provided on the shaft portion of the electrode or the like. The damping material is preferably located on an opposite side of the emission element and reception element to the welding subject. As a result, the reception element can detect a transmitted wave in a specific mode that is emitted from the emission element and reflects the condition of the welding portion accurately.

A sound absorbing material such as rubber or sponge or the like may be cited as an example of the ultrasonic wave damping material. The ultrasonic wave damping material is preferably attached to surround the entire shaft portion of the electrode at the rear (the opposite side to the welding subject) of the ultrasonic wave sensor.

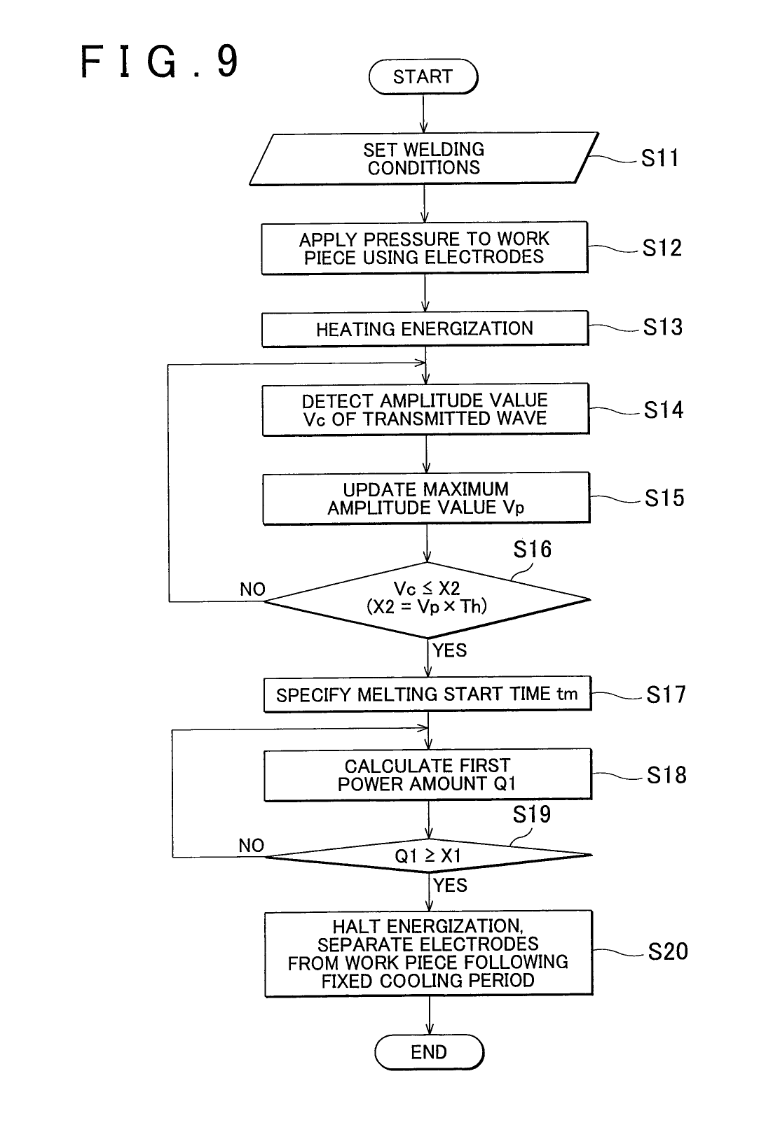

In a rapid reduction time determination process, a rapid reduction time of the transmitted wave amplitude is determined. There are no limitations on a determination method (algorithm). For example, a point at which a detected amplitude value (Vc) of the transmitted wave falls to or below a predetermined proportion of a maximum amplitude value (Vp) detected previously may be determined as the rapid reduction time (see FIG. 9). The comparison subject of the detected amplitude value is not limited to the maximum amplitude value, and instead, an average value (Vave) of the amplitude value during a certain period or the like may be used. Note that amplitude value detection and determination may be paused during an energization period in which the amplitude value is likely to be unstable.

[Electrode]

There are no limitations on a shape, a material, and so on of the electrode. The electrode is normally formed from copper in a columnar or cylindrical shape. When a cylindrical electrode is used, cooling water can be supplied to the interior thereof to cool the electrode forcibly, thereby suppressing wear on the electrode. Hence, a cylindrical electrode is preferable.

An end surface of the electrode that contacts the welding subject externally is normally circular or gently conical. If resistance welding is performed favorably at this time, the shape of the nugget formed in the welding portion is also substantially circular, in accordance with the shape of the electrode end surface. In this case, the size of the nugget is often indicated by the diameter thereof (nugget diameter). Therefore, in this specification, the nugget size will be referred to for convenience as the nugget diameter.

[Power Supply Apparatus]

A power supply apparatus may employ an alternating current power supply or a direct current power supply. The alternating current power supply may be a single phase power supply, a three phase power supply, and so on. Further, the power supply apparatus may be a constant current power supply or a constant voltage power supply. When a constant current power supply is used, the amount of generated Joule heat increases as the welding subject is heated to a steadily higher temperature. As a result, the nugget obtained when the welding subject melts and solidifies is formed more reliably, and therefore a constant current power supply is preferable. Note that a preferable current value supplied to the welding subject from the electrode differs according to the material of the welding subject, the desired nugget diameter, an energization period, and so on.

[Welding Subjects]

There are no limitations on the shape, material, and so on of the welding subjects. Representative welding subjects are laminated steel plates. For example, soft steel plates having a thickness of approximately 0.5 mm to 3 mm and a carbon content (C) of 0.05% by weight to 0.2% by weight are used in resistance welding. Alternatively, materials such as high strength (high tension) steel, galvanized steel, stainless steel, aluminum (Al), Al alloy, copper (Cu), Cu alloy, nickel (Ni), and Ni alloy may serve as the welding subjects. Furthermore, the welding subjects may be constituted by a combination of different materials.

The power amount and so on required to obtain a welding portion having a desired form vary according to the material of the welding subjects. Accordingly, a set value, a melting start power amount, and so on that are compared to a power amount calculated during the resistance welding differ according to the material and form of the welding subjects, the manner in which the welding subjects are laminated, the pressure applied by the electrodes, and so on.

### EXAMPLE

The invention will now be described more specifically, citing an example thereof.

[Input Power Amount and Nugget Formation]

Using a cut model of a work piece (welding subjects) constituted by two laminated steel plates, the steel plates were resistance-welded (spot-welded) under various disturbances, and a condition of a welding spot (welding portion) was photographed using a high-speed camera. The formation process of a nugget formed during the spot welding was then observed.

More specifically, five representative patterns I to V shown in FIG. 1 were set, and spot welding was performed under corresponding conditions. In Pattern I, “No disturbance”, in FIG. 1, the two laminated steel plates were pressed into close contact by electrodes such that a central axis of the electrodes overlapped a normal line passing through the welding portion of the work piece. In Pattern II, “Surface tilt”, the work piece was tilted 3° from a horizontal direction relative to the standard condition of Pattern I. In Pattern III, “Gap between plates”, a gap was formed on the periphery of the welding portion. More specifically, a spacer having a thickness of 1 mm was interposed in positions located 15 mm (φ30 mm) on either side of the welding center of the laminated steel plates. In Pattern IV, “Electrode wear”, the circular shape on the tip end surface (the surface that contacts the work piece) of the electrode was enlarged from de=φ6 mm to de=φ7 mm. Incidentally, the tip end surface of the electrode is connected to a peripheral side face (cylinder surface) of the electrode via a curved surface having a curvature radius of 40 mm. In Pattern V, “Divergence”, the current supplied from the electrode flowed to a spot (an already welded point) other than a present welding spot, in which welding had been completed in a previous process.

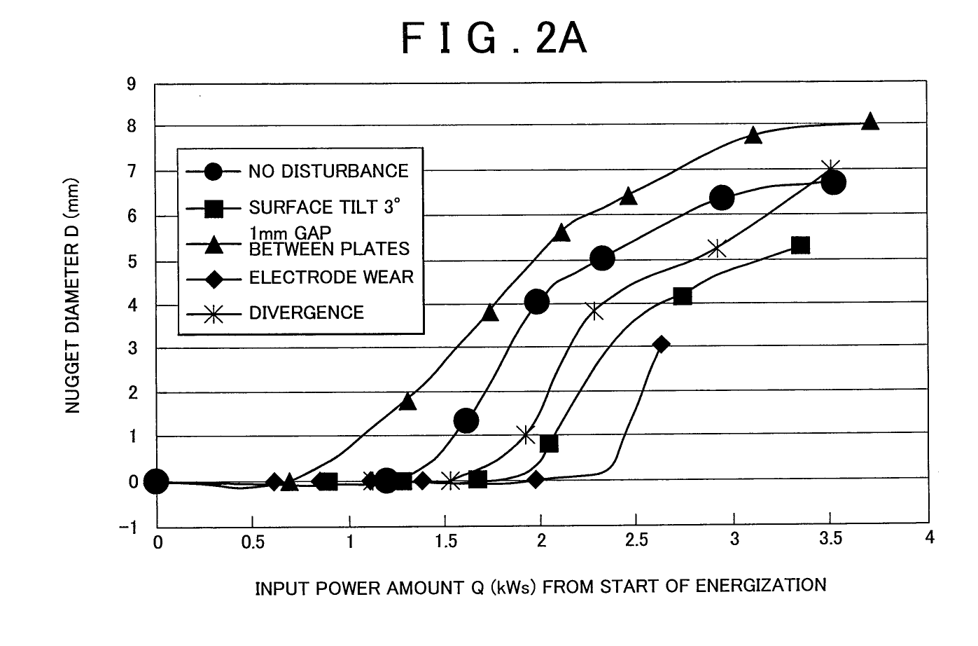

After setting the work piece and the electrode in the respective patterns described above, spot welding was implemented. At this time, an integrated value of the power input into the work piece was calculated as an input power amount Q. Further, a diameter D of a nugget formed in the work piece in accordance with the input power amount Q was measured. A correlation between the input power amount Q determined in this manner and the diameter D of the nugget formed in accordance therewith is shown in FIG. 2A.

Note that the work piece subjected to the spot welding was constituted by two laminated cold-rolled soft steel plates (JIS: SPC270) having a thickness of 2 mm. The employed electrode was cylindrical, and the spot welding was performed while cooling the interior thereof. The tip end portion (electrode chip) of the electrode was shaped as described above. Further, the spot welding was performed while pressing the electrode against the respective outer sides of the work piece. The pressure applied to the work piece by the electrode was set at 3430 N. A 60-cycle, single-phase alternating current was used as the power supply. An effective current value at this time was set at 11 kA. An application period of the heating current was controlled in units of a cycle time Ct ( 1/60 sec).

The input power amount Q calculated here is a time-integrated value of the current applied to the electrodes×a voltage between the electrodes (between the two ends of the work piece), and therefore the input power amount Q is also a function of time. Accordingly, the input power amount at the melting start time (a melting start power amount Qm) can be determined by specifying a timing (the melting start time) at which the existence of a flow caused by melting is confirmed on a cross-section of the cut model.

FIG. 2B shows respective curves shown in FIG. 2A shifted in parallel by an amount corresponding to the melting start power amount Qm. As is evident from FIG. 2B, a substantially common correlation exists between the formed nugget diameter D and a first power amount Q1 (=Q−Qm) obtained by subtracting the melting start power amount Qm from the input power amount Q calculated at the start of energization, regardless of the disturbance pattern. In other words, it was found that by focusing on the melting start time onward, the formed nugget diameter D is substantially determined by the first power amount Q1, regardless of the existence of disturbances and their type.

[Spot Welder]

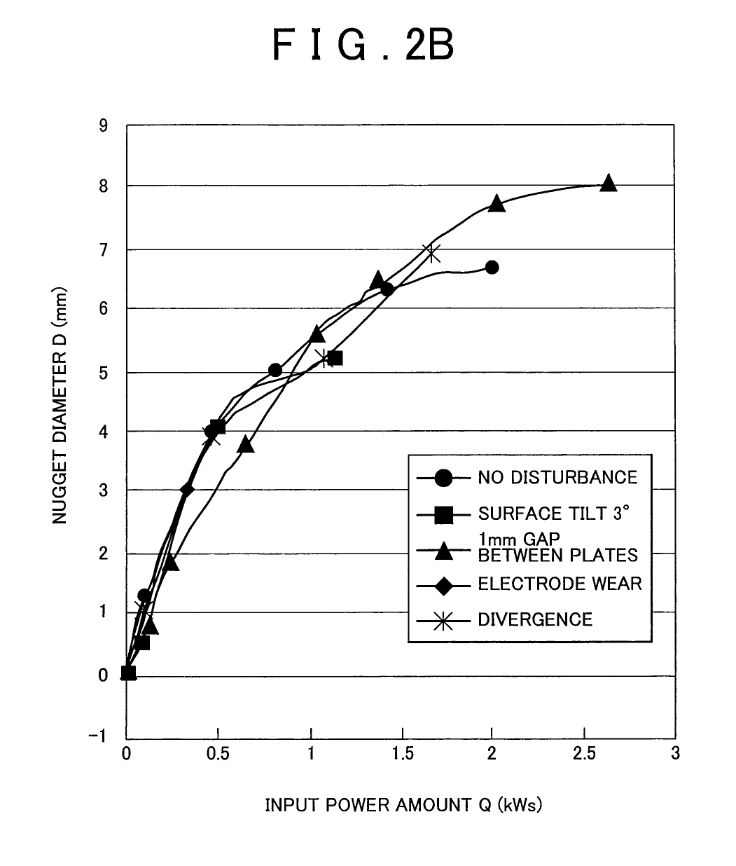

FIG. 3 shows a spot welder 1 serving as an embodiment of the resistance welder according to the invention. The spot welder 1 includes an articulated welding robot 20, a control apparatus 30 that controls the welding robot 20, and a power supply apparatus 40.

The welding robot 20 is a six-axis vertical articulated robot having a base 21 that is fixed to a floor to be capable of rotating about a vertical direction first axis, an upper arm 22 connected to the base 21, a forearm 23 connected to the upper arm 22, a wrist element 24 coupled to a front end portion of the forearm 23 to be free to rotate, and a spot welding gun 10 attached to an end portion of the wrist element 24.

The upper arm 22 is coupled to the base 21 to be capable of rotating about a horizontal direction second axis. The forearm 23 is coupled to an upper end portion of the upper arm 22 to be capable of rotating about a horizontal direction third axis. The wrist element 24 is coupled to a tip end portion of the forearm 23 to be capable of rotating about a fourth axis parallel to an axis of the forearm 23.

The spot welding gun 10 is attached, via another wrist element (not shown) that is capable of rotating about a fifth axis perpendicular to the axis of the forearm 23, to a tip end portion of the wrist element 24 to be capable of rotating about a sixth axis perpendicular to the fifth axis. The spot welding gun 10 is constituted by an inverted L-shaped gun arm 12 and a servo motor 13. A pair of electrodes 11 (a movable electrode 111 and an opposing electrode 112) are disposed on the gun arm 12.

The movable electrode 111 (first electrode) is driven by the servo motor 13 to be free to approach and retreat from a work piece W serving as the welding subject. The movable electrode 111 works in cooperation with the opposing electrode 112 (second electrode), which is disposed coaxially with a thickness direction of the work piece W, to sandwich the work piece W at a desired pressure. Further, the movable electrode 111 and the opposing electrode 112 are made of a copper alloy having a closed-end cylindrical shape, and are cooled forcibly by cooling water that circulates through the interiors thereof.

As shown in FIG. 5, an oblique angle emission element 51 that emits an ultrasonic wave and an oblique angle reception element 52 that receives the ultrasonic wave are attached respectively to the movable electrode 111 and the opposing electrode 112. Arrows in FIG. 5 schematically indicate advancement of the ultrasonic wave. Arrows drawn using solid lines indicate an emission side ultrasonic wave or a reflected wave thereof, while arrows drawn using dotted lines indicate a reception side ultrasonic wave (a transmitted wave) or a reflected wave thereof.

Note that instead of the oblique angle emission element 51 and the oblique angle reception element 52 shown in FIG. 5, an emission element 61 and a reception element 62 such as those shown in FIG. 6 may be used. However, the amplitude of the ultrasonic wave can be detected more easily and more accurately with the oblique angle emission element 51 and the oblique angle reception element 52.

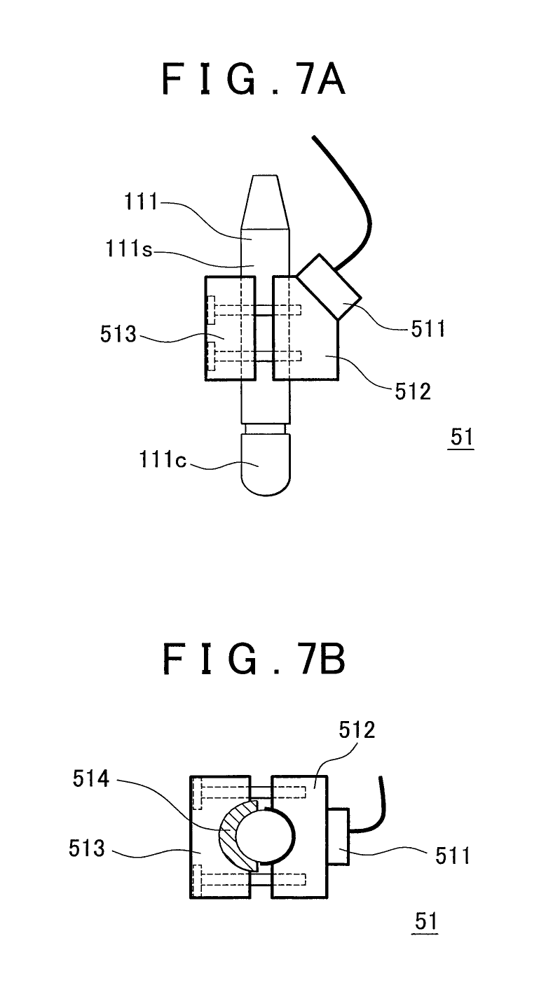

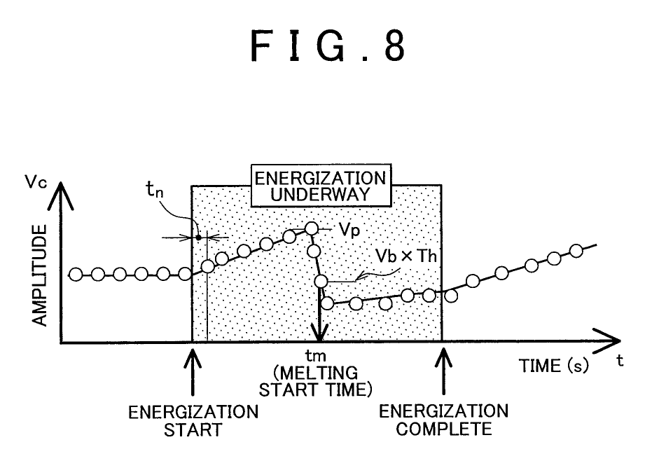

FIGS. 7A and 7B show in detail the oblique angle emission element 51 attached detachably to a shank 111s (a shaft portion of the electrode) that supports a chip 111c attached to a tip end of the movable electrode 111. The oblique angle emission element 51 is constituted by an oscillator 511 formed from a planar ultrasonic wave sensor, a wedge 512 that fixes the oscillator 511 to be oriented toward the work piece W from a diagonal direction relative to the shank 111s of the movable electrode 111, a fixing tool 513 that fixes the wedge 512 to the shank 111s, and an ultrasonic wave damping material 514 that absorbs multiple reflection waves in the shank 111s.

The wedge 512 according to this embodiment is formed from acrylic resin, and an attachment angle of the oscillator 511 is set at 45° relative to an axis of the shank 111s. Note that the attachment angle is preferably set at an optimum angle taking into consideration a speed at which the ultrasonic wave propagates through the shank 111s and a speed at which the ultrasonic wave propagates through the wedge 512.

The ultrasonic wave damping material 514 according to this embodiment is formed from a rubber band that is interposed between an inner peripheral surface of the fixing tool 513 and an outer peripheral surface of the shank 111s. The ultrasonic wave damping material 514 may be wrapped around an opposite side of the oscillator 511 to the work piece W (an upper side in FIG. 7A). Note that the structure and so on of the oblique angle emission element 51 described above applies likewise to the oblique angle reception element 52.

The control apparatus 30 includes a robot drive circuit (not shown) to control driving of the welding robot 20 and the spot welding gun 10. The control apparatus 30 also includes a power circuit (not shown) to control a power (at least one of a voltage and a current) supplied to the work piece W via the electrodes 11. The current value applied to the work piece W, the energization period, an energization timing, a sandwiching force (pressing force) applied to the work piece W by the electrodes 11, and so on are controlled by these circuits. Conditions and data required for this control are input into and downloaded from an operating panel 31.

The power supply apparatus 40 is an alternating current constant current apparatus that is capable of supplying a large constant current with stability by boosting a single-phase power supply or a three-phase power supply. The power supply apparatus 40 is controlled by the power circuit of the control apparatus 30.

The spot welder 1 is operated as follows. The work piece W to be spot-welded is disposed on a carrying table (not shown). Welding conditions such as welding spots of the work piece W, physical property values of the work piece W, the sandwiching force to be applied to the work piece W by the electrodes 11, the current value to be supplied to the electrodes 11, the energization period, and a target value (a first set value) corresponding to the desired nugget diameter are set by being input into the control apparatus 30.

The spot welder 1 is then activated to cause the welding robot 20, which is controlled by the control apparatus 30, to move the spot welding gun 10 to the respective welding spots successively. The electrodes 11 provided on the spot welding gun 10 are driven by the servo motor 13, which is controlled by the control apparatus 30, to sandwich the work piece W by the set pressure. In this condition, a predetermined constant current is supplied to the work piece W from the power supply apparatus 40. By repeating this operation on the plurality of set spots, a spot-welded work piece W (a welded member) is obtained.

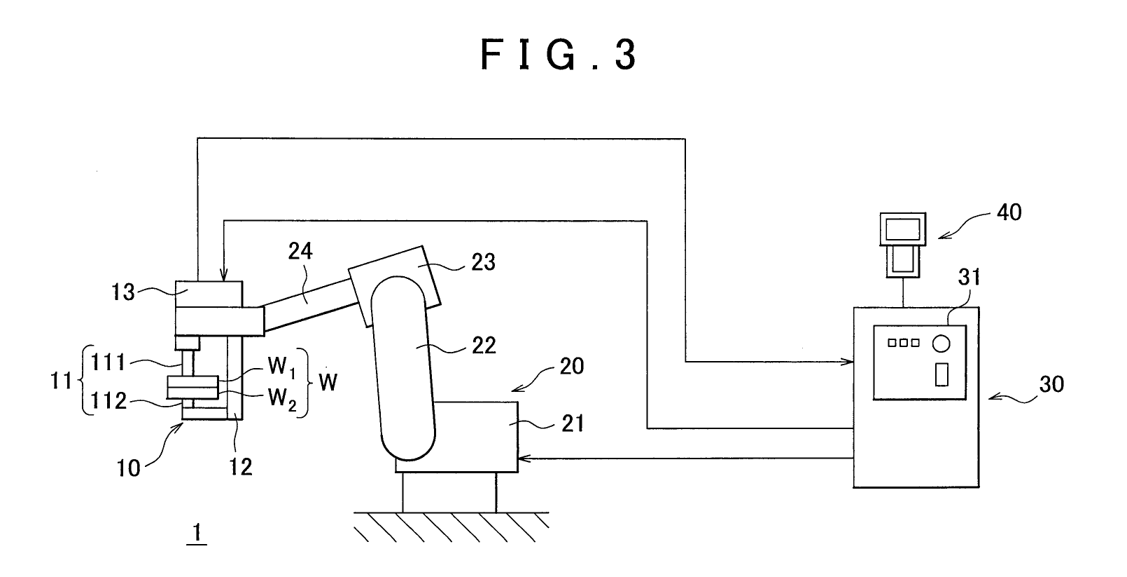

FIG. 4 is a schematic view of a welded spot obtained by the spot welding. When the spot welding is performed favorably, the work piece W melts and solidifies such that the nugget N is formed in the interior of a contact location of the work piece W (a work piece W1 and a work piece W2) constituted by soft steel plates. Note that a part that is pressed and heated by the electrodes 11 serves as a welding portion Y, and the nugget N is normally enveloped by the welding portion Y Further, a maximum diameter of the nugget N is set as the nugget diameter.

[Control Apparatus and Control Method for Spot Welder]

The control apparatus 30 according to this embodiment of the invention further includes a monitoring circuit (not shown) that monitors the welding condition of the welded spots.

The monitoring circuit includes a melting start time specification unit that specifies the melting start time, i.e. the point at which at least a part of the work piece W starts to melt while being Joule-heated by the power input from the electrodes 11, a first power amount calculation unit that calculates the first power amount Q1 input into the work piece W via the electrodes 11, and a first determination unit that determines whether the integrated first power amount Q1 has reached a first set value X1 (in other words, whether Q1≧X1). Further, the monitoring circuit Joule-heats the work piece W by supplying power to the work piece W via the aforementioned power circuit until the first power amount Q1 reaches the first set value X1 (a heating unit).

The melting start time specification unit of the monitoring circuit includes a transmitted wave amplitude detection unit that receives a transmitted wave, which is an ultrasonic wave emitted from the oblique angle emission element 51 so as to pass through the welding portion Y, in the oblique angle reception element 52 and detects the amplitude value (Vc) of the transmitted wave, and a rapid reduction time determination unit that determines a point at which Vc falls to or below a second set value (X2) (Vc≦X2) as the rapid reduction time of the transmitted wave amplitude. Thus, the melting start time specification unit specifies the rapid reduction time as the melting start time (t=tm).

FIG. 9 is a flowchart of a specific control method employed by the control apparatus 30 to control the spot welder 1. By executing the control method shown in FIG. 9, each process of the resistance welding method according to the invention is realized, and as a result, the resistance-welded work piece W (welded member) is manufactured.

First, in Step S11, various welding conditions and data are input and set (setting step). More specifically, the material and plate thickness of the work pieces W1, W2, the number of welding spots and their positions, a chip shape of the electrodes 111, 112, the pressure to be applied to the work piece W by the electrodes 11, a heating current value I1 to be employed during the spot welding, the cycle time Ct, the first set value X1 corresponding to the desired nugget diameter, various parameters required to detect the amplitude value Vc of the transmitted wave, the second set value X2 (a calculation formula) required to determine the rapid reduction time of the amplitude value Vc, and so on are input and set.

In Step S12, the welding robot 20 and the spot welding gun 10 are operated such that electrode end surface portions (electrode chips) of the electrodes 111, 112 impinge on (externally contact) the respective outer sides of the work piece W. The electrodes 11 press the work piece W on the basis of the settings of Step S11 (pressing step).

In Step S13, heating energization is performed for the spot welding. In other words, the heating current value I1 is supplied to the electrodes, whereby the spot welding begins (heating process).

In Step S14, the amplitude value Vc of the transmitted wave emitted by the oblique angle emission element 51 and received by the oblique angle reception element 52 is detected. To ensure that Vc is detected with stability at this time, a small amount of time (tn) at the start of energization is set as a void period and Vc detection is not performed therein. In other words, the amplitude value Vc of the transmitted wave is detected in a section (t tn) following the void period (transmitted wave amplitude detection process). Note that a time width (Δt) of the detection step is set at a single period (1 Ct) of the supplied alternating current, similarly to calculation of the first power amount Q1.

In Step S15, a maximum value (the maximum amplitude value Vp) of the amplitude value Vc detected from the start of Step S14 onward (t≧tn) is stored. Whenever an amplitude value Vc (Vc>Vp) that exceeds the maximum amplitude value Vp is detected, Vp is updated by the newly detected Vc value.

In Step S16, the amplitude value Vc detected in Step S14 is compared with the second set value X2 determined from the previously detected maximum amplitude value Vp (rapid reduction time determination process). Here, the second set value X2 is calculated on a case by case basis as X2=Vp×Th. Th is a parameter set appropriately in accordance with characteristics of the oblique angle emission element 51, the oblique angle reception element 52, the electrodes 11, the work piece W, and so on, at a fixed value between 0.2 and 0.6, for example.

When, in Step S16, the amplitude value Vc of the transmitted wave is greater than the second set value X2, the processing returns to Step S14, where detection of the amplitude value Vc is continued. When, on the other hand, the amplitude value Vc is equal to or smaller than the second set value X2 (Vc≦X2), it is determined that a rapid reduction has occurred in the transmitted wave amplitude, and the processing advances to Step S17.

In Step S17, a time (t) at which Vc≦X2 was established is set as the melting start time (t=tm) (melting start time specification process).

In Step S18, the first power amount Q1 input into the work piece W is calculated in accordance with the energization period (melting energization period: t−tm) from the melting start time tm (first power amount calculation process).

In Step S19, the first power amount Q1 calculated from the melting start time tm onward is compared with the first set value X1 corresponding to the desired nugget diameter (first determination process). When the first power amount Q1 is smaller than the first set value X1, the processing returns to Step S18, where heating energization of the work piece W is continued.

When the first power amount Q1 has reached the first set value X1 in Step S19, on the other hand, the processing advances to Step S20, where heating energization of the work piece W is halted. The electrodes 11 are then separated from the work piece W, whereby spot welding in the corresponding position is terminated (heating process).

Although not shown in the flowchart of FIG. 9, the conditions of the heating energization may be amended or modified when Steps S18 and S19 have been repeated a predetermined number of times or for a predetermined period (number of cycle times) or more (heating modification process). Further, in abnormal cases such as when a rapid reduction is not detected in the amplitude value Vc in Step S16 even after the elapse of a predetermined time, the processing may be terminated forcibly.

[Spot Welding Evaluation Method]

The welding condition of the spot welding may be evaluated using Steps S14 to S19 in FIG. 9. The quality of the welding condition alone can be evaluated from a magnitude relationship between the first power amount Q1 and the first set value X1, as shown in Step S19 (estimation process, evaluation process). Further, by preparing in advance a database associating the first power amount Q1 with the nugget diameter D, such as that shown in FIG. 2B, the diameter D of the nugget formed in the welding portion can be estimated from the actually integrated first power amount Q1 (nugget estimation process, estimation process, evaluation process).

While the invention has been described with reference to example embodiments thereof, it is to be understood that the invention is not limited to the described embodiments or constructions. To the contrary, the invention is intended to cover various modifications and equivalent arrangements. In addition, while the various elements of the disclosed invention are shown in various example combinations and configurations, other combinations and configurations, including more, less or only a single element, are also within the scope of the appended claims.

1. A resistance welding method comprising:
specifying a melting start time, which is a time at which at least a part of a welding portion of a welding subject starts to melt while being subjected to Joule heating by a power input from an electrode pressed against the welding subject, by detecting a variation in an ultrasonic wave emitted toward the welding portion;
calculating a first power amount, which is an integrated value of the power input into the welding subject via the electrode from the melting start time;
determining whether or not the first power amount or a welding index value that indexes a welding condition of the welding portion and corresponds to the first power amount has reached at least a first set value; and
performing the Joule heating from the melting start time until the first power amount or the welding index value reaches at least the first set value,
wherein a nugget generated when the welding portion melts and solidifies is formed with stability.

2. The resistance welding method according to claim 1, wherein specifying a melting start time includes:
detecting a transmitted wave amplitude, which is an amplitude of an ultrasonic wave that passes through the welding portion; and
determining a rapid reduction time at which the transmitted wave amplitude falls to or below a second set value.

3. The resistance welding method according to claim 1, wherein performing the Joule heating includes modifying a heating condition of the welding subject on the basis of a determination result obtained by determining whether or not the first power amount or the welding index value has reached at least the first set value.

4. A resistance-welded member welded using the resistance welding method according to claim 1.

5. A control apparatus for a resistance welder having an electrode that contacts a welding subject externally and a power supply apparatus that supplies a heating current to the electrode in order to Joule-heat a welding portion of the welding subject,
the control apparatus comprising:
a melting start time specification unit that specifies a melting start time, which is a time at which at least a part of the welding portion starts to melt while being subjected to Joule heating by a power input into the welding subject from the electrode, by detecting a variation in an ultrasonic wave emitted toward the welding portion;
a first power amount calculation unit that calculates a first power amount, which is an integrated value of the power input into the welding subject via the electrode from the melting start time;
a first determination unit that determines whether or not the first power amount or a welding index value that indexes a welding condition of the welding portion and corresponds to the first power amount has reached at least a first set value; and
a heating unit that performs the Joule heating from the melting start time until the first power amount or the welding index value reaches at least the first set value.

6. A resistance welder comprising:
an electrode that is pressed against a welding subject;
a power supply apparatus that supplies a heating current to the electrode in order to Joule-heat a welding portion of the welding subject;
an ultrasonic wave sensor that emits an ultrasonic wave toward the welding portion of the welding subject; and
the control apparatus according to claim 5.

7. The resistance welder according to claim 6, wherein
the electrode is constituted by a first electrode and a second electrode that are pressed respectively against the welding subject from two substantially coaxial sides, and
the ultrasonic wave sensor is constituted by an emission element that is attached to a shaft portion of the first electrode in order to emit the ultrasonic wave and a reception element that is attached to a shaft portion of the second electrode in order to receive the ultrasonic wave emitted by the emission element.

8. The resistance welder according to claim 7, wherein the emission element is an oblique angle emission element that emits the ultrasonic wave in a direction of the welding subject from a diagonal direction relative to the shaft portion of the first electrode, and the reception element is an oblique angle reception element that receives the ultrasonic wave emitted by the oblique angle emission element in the direction of the welding subject from a diagonal direction relative to the shaft portion of the second electrode.

9. The resistance welder according to claim 7, further comprising an ultrasonic wave damping material that is provided on the shaft portion of the first electrode or the shaft portion of the second electrode on an opposite side of the emission element or the reception element to the welding subject in order to damp the ultrasonic wave.

10. A control method for a resistance welder having an electrode that contacts a welding subject externally and a power supply apparatus that supplies a heating current to the electrode in order to Joule-heat a welding portion of the welding subject,
the method comprising:
specifying a melting start time, which is a time at which at least a part of the welding portion starts to melt while being subjected to Joule heating by a power input into the welding subject from the electrode, by detecting a variation in an ultrasonic wave emitted toward the welding portion;
calculating a first power amount, which is an integrated value of the power input into the welding subject via the electrode from the melting start time;
determining whether or not the first power amount or a welding index value that indexes a welding condition of the welding portion and corresponds to the first power amount has reached at least a first set value; and
performing the Joule heating from the melting start time until the first power amount or the welding index value reaches at least the first set value.

11. A computer-readable storage medium that stores computer-executable instructions for performing the control method for a resistance welder according to claim 10.

12. A resistance welding evaluation method comprising:
specifying a melting start time, which is a time at which at least a part of a welding portion of a welding subject starts to melt while being subjected to Joule heating by a power input from an electrode pressed against the welding subject, by detecting a variation in an ultrasonic wave emitted toward the welding portion;
calculating a first power amount, which is an integrated value of the power input into the welding subject via the electrode from the melting start time; and
estimating a welding condition of the welding portion on the basis of the first power amount.

13. The resistance welding evaluation method according to claim 12, wherein the welding condition of the welding portion is estimated by estimating, on the basis of the first power amount, a size of a nugget formed when the welding portion melts and solidifies.

14. A computer-readable storage medium that stores computer-executable instructions for performing the resistance welding evaluation method according to claim 12.
